(19) United States
(12) Patent Application Publication
(10) Pub. No.: US 2018/0164182 A1
(43) Pub. Date: Jun. 14, 2018

(54) SYSTEM, METHOD AND APPARATUS FOR PULSATING PRESSURE MEASUREMENT

(71) Applicant: Westlake Chemical Corporation, Houston, TX (US)

(72) Inventor: Christopher J. Willy, Longview, TX (US)

(21) Appl. No.: 15/833,821

(22) Filed: Dec. 6, 2017

Related U.S. Application Data
(60) Provisional application No. 62/432,478, filed on Dec. 9, 2016.

(51) Int. Cl. G01M 13/00; G01M 3/26; G01L 23/00

(52) U.S. Cl. CPC G01M 13/005; G01L 23/00; G01M 3/26

(57) ABSTRACT

A testing system for pulsating pressure measurement of the pressure of a fluid in dynamic pressure service in a pipe system is disclosed. For example, the testing system can include an accelerometer mounted to an exterior of the pipe system. An analyzer can be provided for sampling and filtering data from the only one accelerometer. In addition, a computer can be provided for running an algorithm to convert the data from the only one accelerometer to data regarding the pressure of the fluid in the pipe system.

This application claims priority to and the benefit of U.S. Prov. Pat. App. No. 62/432,478, filed Dec. 9, 2016, which is incorporated herein by reference in its entirety.

### BACKGROUND OF THE INVENTION

### Field of the Disclosure

The present invention relates in general to pulsating pressure and, in particular, to a system, method and apparatus for measuring and monitoring pulsating pressure.

### Description of the Prior Art

In some applications, compressors are used to boost a process pressure to an elevated reactor pressure. A conventional compressor can include cylinders with pistons and seals, such as piston rings, located between the pistons and the cylinders. The health of the piston rings inside the cylinder can have a significant impact on the performance of the system. For example, cylinders become distressed and are unable to compress the process stream when one or more of the piston rings are damaged.

Unfortunately, it is often difficult to diagnose which cylinders in a compressor can contain damaged piston rings. A conventional technology for measuring pulsating flow includes strain gauges. Strain gauges are very delicate and difficult to install, requiring either in-line installation like a strain-ring, specialized washers installed on bolting, or epoxying strain gauges onto cylinders or bores. In addition, the cost of repairing a compressor (or the wrong compressor) can be very costly, both in terms of repairing the damage itself and the lost revenue from the downtime of the compressor being out of service. Thus, improvements in diagnosing damaged compressors continue to be of interest.

### SUMMARY

Embodiments of a testing system for pulsating pressure measurement of a pressure of a fluid in a pipe system are disclosed. For example, the testing system can include only one accelerometer mounted to an exterior of the pipe system. An analyzer can be provided for sampling and filtering data from the only one accelerometer. In addition, a computer can be provided for running an algorithm to convert the analyzed data to the pressure of the fluid in the pipe system.

In another embodiment, a mobile testing system for measuring a pulsating pressure of a fluid in a pipe system is disclosed. For example, the mobile testing system can include only one sensor configured to only be magnetically mounted to an exterior of the pipe system, such that the only one sensor is not mounted to the exterior of the pipe system in any other way other than through magnetism. In addition, an analyzer can be configured to sample and filter data from the only one sensor. A computer also can be configured to run an algorithm to convert the analyzed data to data regarding the pulsating pressure of the fluid in the pipe system.

An embodiment of a testing system for pulsating pressure measurement of a pressure of a fluid in a pipe system can include at least one accelerometer mounted to the piping system. The at least one accelerometer can be mounted to an exterior of a pipe of the piping system and measures vibration in and dilation of an outer diameter of the pipe. An analyzer can be provided that samples and filters data from the at least one accelerometer. In addition, a computer can be configured to run an algorithm to convert the data to infer the pressure of the fluid in the pipe system.

Still another version of a testing system can evaluate the efficiency of a reciprocating system. The reciprocating system can have a cylinder with a piston, an intake port for directing a fluid to the piston, a discharge port for directing the fluid away from the piston, and a leak-off pipe coupled to the cylinder for any of the fluid that blows by the piston. Embodiments of the testing system can include a plurality of sensors. At least one of the sensors can be mounted to an exterior of each of the intake port, the discharge port and the leak-off pipe, without direct contact with and sampling of the fluid inside the reciprocating system. A computation system can be coupled to the intake port sensor for inferring an intake pressure of the fluid in the intake port based on data from the intake port sensor; the discharge port sensor for inferring a discharge pressure of the fluid in the discharge port based on data from the discharge port sensor; and the leak-off pipe sensor for inferring a leak pressure of the fluid in the leak-off pipe based on data from the leak-off pipe sensor. In addition, the testing system can be configured to calculate the efficiency of the reciprocating system based on the intake pressure, the discharge pressure and the leak pressure.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description can be had by reference to the embodiments thereof that are illustrated in the appended drawings. However, the drawings illustrate only some embodiments and therefore are not to be considered limiting in scope as there can be other equally effective embodiments.

FIG. 1 is a schematic diagram of a conventional reciprocating system.

FIG. 2 is a conventional waveform sample of a leaking reciprocating system.

FIG. 3 is a conventional orbital plot of the waveform of FIG. 2, with the cycles overlaid on each other by matching the rotational speed of the reciprocating system to the data collected.

FIG. 4 is a schematic diagram of an embodiment of a system for pulsating pressure measurement.

FIG. 5 is a schematic diagram of an embodiment of an analyzer.

FIG. 6 is a schematic diagram of an embodiment of a computer.

FIG. 7 is a flowchart of an embodiment of a system for pulsating pressure measurement.

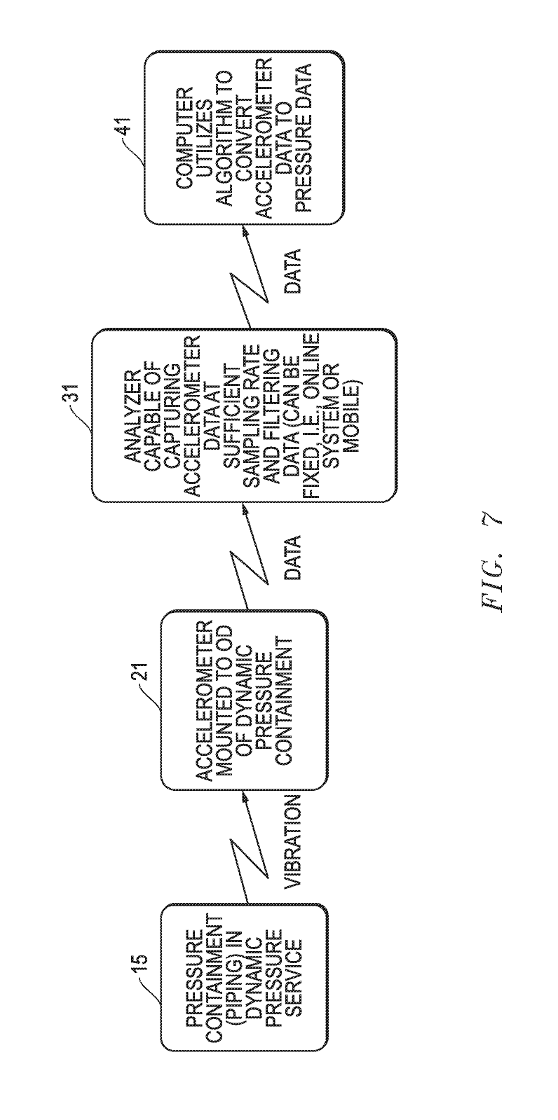

FIG. 8 is a plot of vibration amplitude over time.

FIG. 9 is a plot of acceleration and velocity data over time.

FIG. 10 is plot of velocity and displacement data over time.

FIG. 11 is a plot of baseline vibration over time.

FIG. 12 is a plot of pressure induced pipe dilation over time.

The use of the same reference symbols in different drawings indicates similar or identical items.

### DETAILED DESCRIPTION

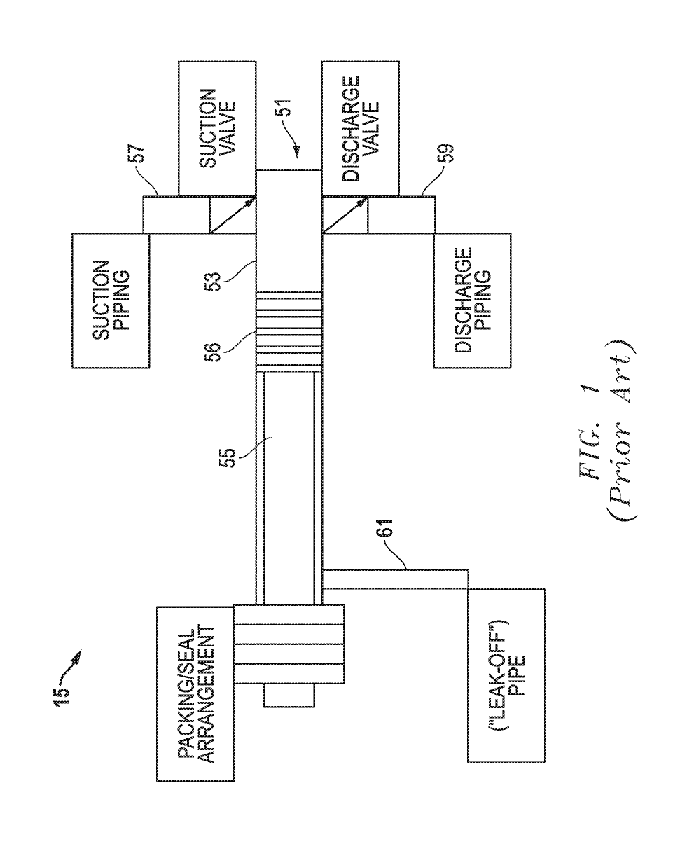

FIG. 1 depicts a schematic diagram of a conventional compressor 51 having a pipe system 15. The pipe system 15 can include at least one cylinder 53 with a piston 55, an intake port 57 for directing fluid to the piston 55, and a discharge port 59 for directing fluid away from the piston 55. Some versions of the pipe system 15 have an array of these cylinders 53. In addition, the pipe system 15 can include a leak-off pipe 61 that can be coupled to the cylinder 53 for any fluid that blows by the piston 55. In some versions, the compressor 51 can include a sealing system between the cylinder 53 and the piston 55. For example, the sealing system can comprise a packing or piston rings 56.

For such a compressor 51 with a leak-off pipe 61 for fluid that blows by the piston rings 56, the fluid flow characteristics can be expressed in terms of pipe vibration and dilation, which is natively expressed in terms of acceleration or “g's”. The basic premise is that when the piston rings 56 are worn, or become damaged and/or broken, the process fluid exits through the leak-off pipe 61, which causes it to vibrate and dilate.

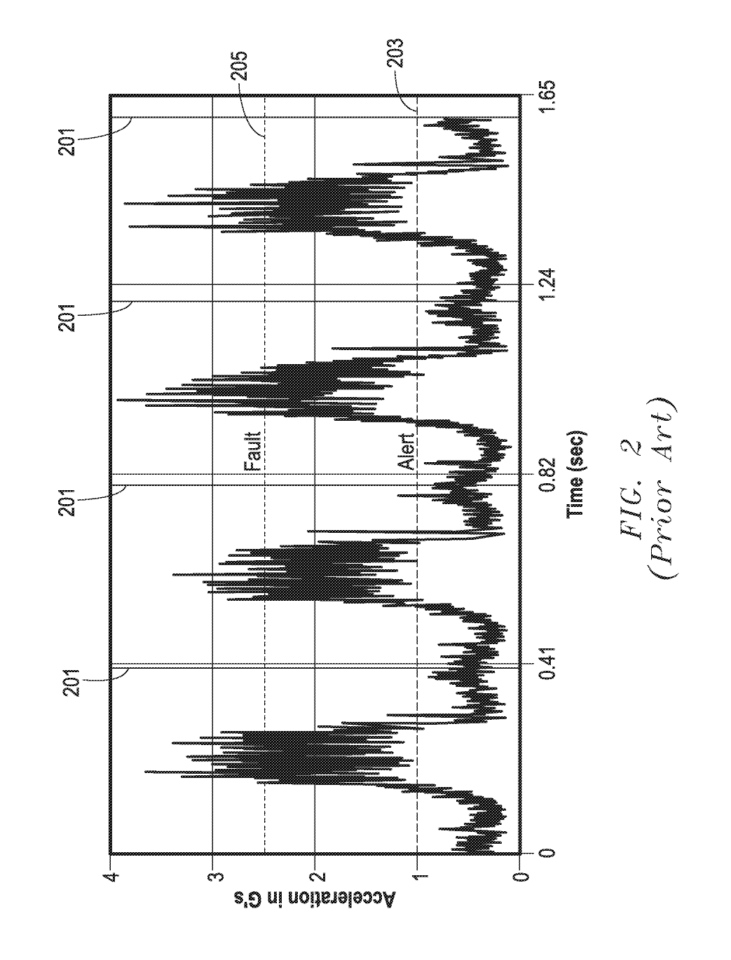

As depicted in FIG. 2, the fluid flow-inducing vibration and dilation in a pipe can be observed in accordance with an embodiment of a testing system. For reference purposes, the vertical lines 201 approximate the revolutions of the compressor 51. The horizontal line 203, marked “Alert”, is set at 1 g of acceleration, which can be used to indicate cylinders 53 that are beginning to show symptoms of degradation (e.g., wear) of one or more rings 56. The horizontal line 205, marked “Fault”, corresponds to the level (2.5 g) of fluid flow that (for the conventional system of FIG. 1) has historically and consistently correlated with broken, damaged and/or missing piston rings 56.

The waveform shown in FIG. 2 illustrates a characteristic “leaker” pattern for damaged piston rings 56 over several cycles of the reciprocating system 15. The waveform of FIG. 2 indicates consistent flow during the discharge stroke of the piston 55. However, instead of compressing the fluid toward the discharge port 59, the piston rings 56 are allowing at least some of the fluid to blow by them and flow to the leak-off pipe 61.

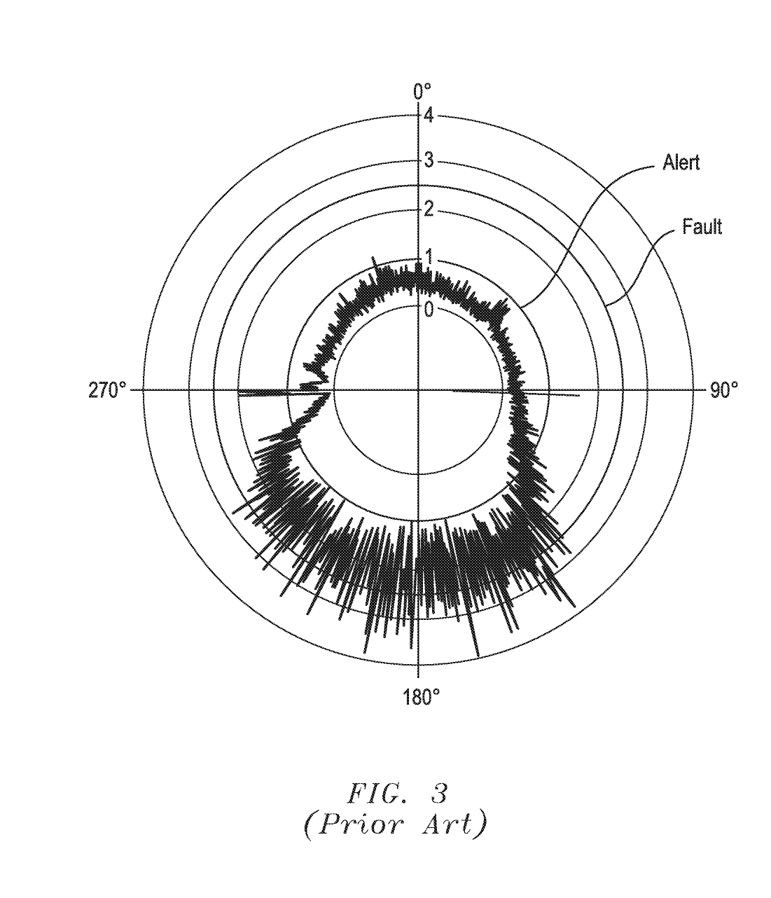

FIG. 3 shows the same waveform of FIG. 2, but in an orbital plot with the cycles of FIG. 2 overlaid on each other. This is an alternate way of relating the waveform to the rotational speed of the compressor 51 (FIG. 1). These “snapshots” of compressor leak-off permit qualitative determination of which cylinder's piston rings 56 are damaged (which allows fluid blow-by), thereby eliminating guesswork when selecting cylinders for repair of excessive leak-off.

Prior to the detection system and method of the present application, observance of ice accumulation on the pipe system 15 was used to determine which cylinders 53 were thought to be leaking. Ice accumulation is a quite inaccurate predictor of cylinder damage, and often results in the repair of a cylinder that was not in need of repair. However, as described herein, the disclosed embodiments can very accurately identify a damaged cylinder with a simple, portable, robust and very reliable system for identifying irregular pulsating flow.

Vibration and dilation of a pipe can be captured with high speed data acquisition. For example, as the piston rings 56 (FIG. 1) wear, an increase in pulsating vibration through the leak-off pipe 61 is observed. The dilation measurement can be collected with a sensor, such as a conventional accelerometer, having a high sampling rate. In addition, a high-pass filter can be applied to the waveform to limit the recorded data to high frequency vibrations.

Versions of the accelerometer can be magnetically attached to the system being monitored. This allows a user to quickly mount and collect many samples, such as hundreds of samples on different systems, each day with an extremely high level of repeatability.

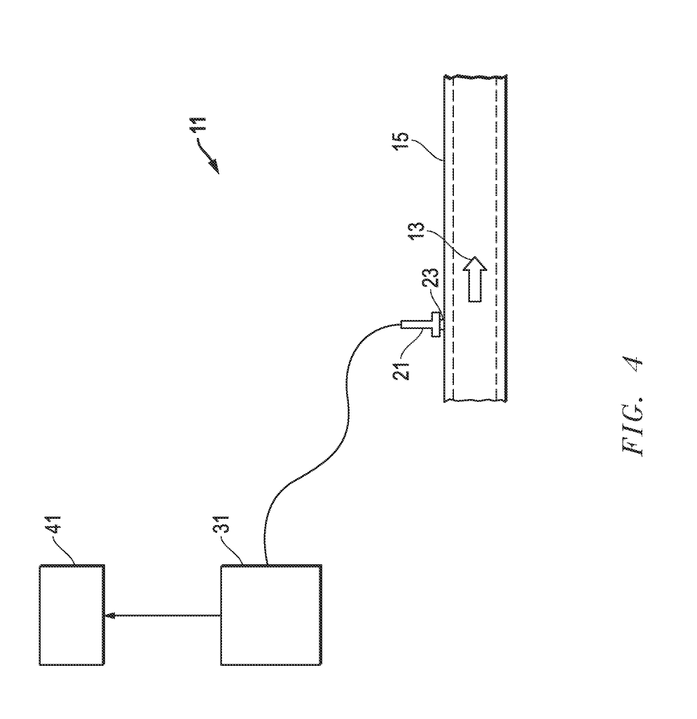

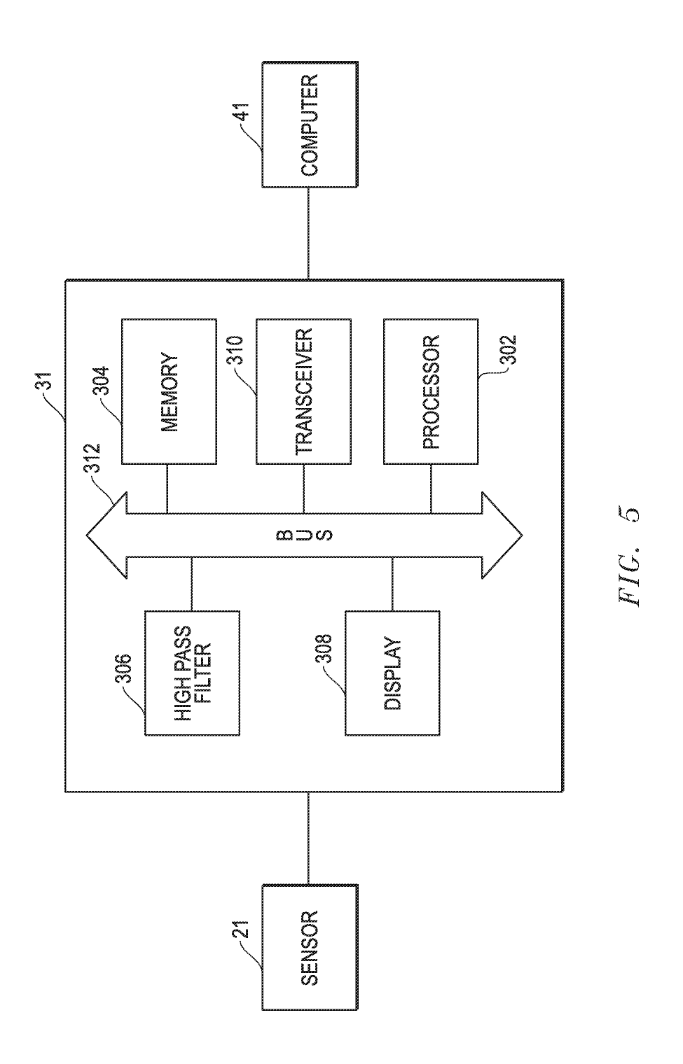

Embodiments of a system, method and apparatus pulsating pressure measurement can include many variations. For example, as shown in FIGS. 4 and 5, embodiments of a testing system 11 can be used for pulsating pressure measurement of a pressure of a fluid 13 in dynamic pressure service in the pipe system 15. The term “dynamic pressure service” can imply pressure changes in the pipe system 15, such as cyclical pressure. Cyclical pressure can be induced by a reciprocating device, such as a compressor, a pump and the like.

Examples of the pipe system 15 can operate at a selected range of pressures. In some versions, the pressure of the fluid 13 in the pipe system 15 can be at least about 50 psi, such as at least about 100 psi, or even at least about 200 psi. In other examples, the pressure can be not greater about 50,000 psi, such as not greater than about 35,000 psi, or even not greater than about 25,000 psi. Embodiments of the pressure of the fluid also can be in a range between any of these values.

Some versions of the testing system 11 can include a sensor 21. For example, the sensor 21 can comprise an accelerometer. Embodiments of the sensor 21 can consist of only one accelerometer. Versions of the accelerometer can comprise, for example, a 10.2 mV/m/s² or 100 mV/G general purpose accelerometer, such as a 2-PIN Accelerometer, A0720GP, sold by Emerson Reliability Systems, 835 Innovation Drive, Knoxville, Tenn. 37932.

Embodiments of the sensor 21 are contemplated to exclude other types of sensors, such as strain gages, or sensors that directly interface with the fluid 13 in the pipe system 15.

In some versions, the only one accelerometer is the only sensor 21 of the testing system 11, such that the testing system 11 comprises no other sensors 21. In another example, the testing system 11 can include no sensors 21, including the only one accelerometer, that are directly exposed to the fluid 13 for directly monitoring and interfacing with the fluid 13 in the pipe system 15. Accordingly, the sensor 21 can be used to detect vibration in and dilation of the outer diameter of the pipe of the pipe system 15 to infer the pressure of the fluid 13 inside the pipe system 15, without ever coming in contact with the fluid itself.

Embodiments of the sensor 21 can be mounted to an exterior of the pipe system 15. For example, the sensor 21 can be directly mounted to a pipe of the pipe system 15 at an outer diameter of the pipe. The testing system 11 can further include a pad 23, such as a mounting pad. In one version, the pad 23 can be directly mounted to an exterior of a pipe of the pipe system 15. Examples of the sensor 21 can be directly mounted to the pad 23, such that the sensor 21 is not directly mounted to the pipe of the pipe system 15.

The testing system 11 can further include embodiments of an analyzer 31 as shown in FIG. 5. For example, the analyzer 31 can be provided for sampling and filtering data from the sensor 21. In one version, the analyzer 31 can comprise the 2130 portable analyzer, sold by CSI, 835 Innovation Drive, Knoxville, Tenn. 37932.

The analyzer 31 can include at least one processor 302 and at least one memory 304. The processor(s) 302 generally operate to process data and control the overall operation of the analyzer 31. Each processor 302 can denote any suitable processing device, such as a Central Processing Unit (CPU), Application Processor (AP), or Communication Processor (CP). Each memory 304 can be used to store and facilitate retrieval of instructions and data used, generated, or collected by the analyzer 31. Each memory 304 can include any suitable volatile or non-volatile memory device. An example of software suitable for some embodiments is Machinery Health Manager V. 5.6, from CSI, 835 Innovation Drive, Knoxville, Tenn. 37932.

The processor(s) 302 can control a sampling rate. In some examples of the analyzer 31, the sampling rate can be at least 10,000 samples per second, such as at least about 50,000 samples per second, or even at least about 100,000 samples per second. In other versions, the sampling rate can be not greater than about 1,000,000 samples per second, such as not greater than about 500,000 samples per second, or even not greater than about 125,000 samples per second. Embodiments of the sampling rate can be in a range between any of these values. The higher the sampling rate, the higher the resolution of the pulsating pressure wave form.

Versions of the analyzer 31 also can include a filtering capability. For example, the analyzer 31 can include a high pass filter 306. The high pass filter 306 can be characterized as an electronic filter that passes signals with a frequency higher than a certain cutoff frequency, and attenuates signals with frequencies lower than the cutoff frequency. These components can comprise a portion of the software integral to the analyzer used, such as the one described herein.

The amount of attenuation for each frequency can be dependent on the filter design. Embodiments of the high pass filter can be applied to a waveform of the data from the sensor 21. Versions of the high pass filter can be used to limit the data from the sensor 21 to the analyzer 31 to vibrations at a minimum selected frequency. For example, the frequency can be at least about 100 Hz, such as at least about 500 Hz, or even at least about 1000 Hz.

A display 308 can be used to present information to a user. The display 308 could present a user interface (UI) that permits a user to interact with the analyzer 31 and any software or programs being executed on the analyzer 31. Such interaction can include setting the sampling rate or checking the status of the analyzer. The analyzer can also include at least one transceiver 310. The transceiver(s) 310 can communicate data to or from the analyzer 31 in any suitable manner. Any suitable wireless communication protocols could be supported by the transceiver(s) 310, such as cellular, WI-FI®, or BLUETOOTH®. The transceiver(s) 310 can also support any wired communication protocol. The transceiver(s) 310 can support the transmission and reception of any suitable data. The transceiver(s) samples the sensor 21 based on the sampling rate set by the processor(s) 302.

Each bus 312 can denote any suitable communication bus that interconnects with and delivers data or other signals between components 302-310. While one bus 312 is shown here, different buses 312 could couple different components in the analyzer 31.

Although FIG. 5 illustrates one example of an analyzer 31 for use in a testing system, various changes can be made to FIG. 5. For example, various components in FIG. 5 could be combined, further subdivided, or omitted and additional components could be added according to particular needs. Also, analyzers can come in a wide variety of configurations, and FIG. 5 does not limit this disclosure to any particular analyzer.

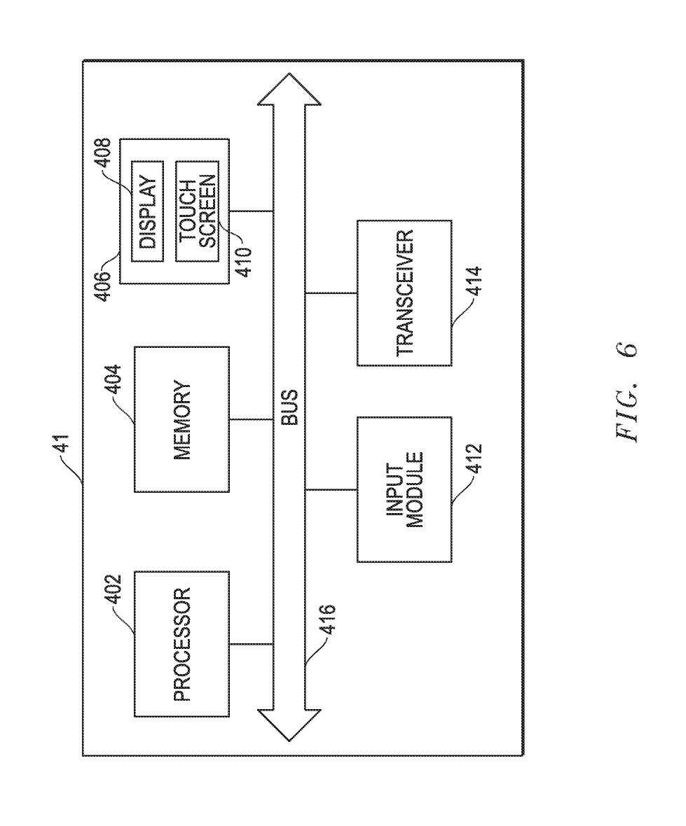

Embodiments of the testing system 11 also can include a computer 41 as shown in FIG. 6. For example, and as described elsewhere herein, the computer 41 can be provided for running an algorithm to convert the data from the analyzer 31 to data regarding the pressure of the fluid 13 in the pipe system 15. Such a computer can comprise the ProBook 6470b, from HP Inc., 1501 Page Mill Road, Palo Alto, Calif. 94304.

As shown in FIG. 6, the computer 41 can include at least one processor 402 and at least one memory 404. The processor(s) 402 generally operate to process data and control the overall operation of the computer 41. Each processor 402 can denote any suitable processing device, such as a Central Processing Unit (CPU), Application Processor (AP), or Communication Processor (CP). Each memory 404 can be used to store and facilitate retrieval of instructions and data used, generated, or collected by the computer 41, such as the applications 108 and 110. Each memory 404 includes any suitable volatile or non-volatile memory device.

The computer 41 also can include at least one display module 406. The display module(s) 406 can be used to present information to a user and to optionally receive input from a user. For example, the display module(s) 406 could include a display 408 and a touch screen 410 (which could be integrated into a single touch screen display). The display 408 could present a user interface (UI) that permits a user to interact with the computer 41 and any software or programs being executed on the computer 41. The touch screen 410 can capture user input when the user taps, slides, or otherwise touches the touch screen 410.

In addition, the computer 41 can include at least one input module 412, at least one transceiver 414, and at least one bus 416. The input module(s) 412 can support the receipt of data from a user's input device(s) in any suitable manner. For example, an input module 412 could receive input from an electronic pen capable of interacting with the display module 406 or a keyboard incorporated into the computer 41, a virtual keyboard, or an external keyboard. Other input devices that could be used include a mouse or touch pad. The transceiver(s) 414 can communicate data to or from the computer 41 in any suitable manner. As noted above, any suitable communication protocols could be supported by the transceiver(s) 414, such as cellular, WIFI®, or BLUETOOTH®. The transceiver(s) 414 can support the transmission and reception of any suitable data.

Each bus 416 can denote any suitable communication bus that interconnects with and delivers data or other signals between components 402-414. While one bus 416 is shown here, different buses 416 could couple different components in the computer 41.

Versions of the testing system 11 can be configured for use with pipe systems 15 that are in fluid communication with a reciprocating device. In general, reciprocating devices create pressure in pipe systems. As noted herein, examples of reciprocating devices can include compressors, pumps and the like. One example is illustrated in FIG. 1, where the testing system 11 is configured to be coupled to a pipe system 15 having the compressor 51.

Embodiments of the sensor 21 can be located upstream, downstream or adjacent to the reciprocating device. For example, the sensor 21 can be mounted to the leak-off pipe 61. In other versions, the sensor 21 can be only magnetically mounted to one of the intake port 57, the discharge port 59 and the leak-off pipe 61, or even the reciprocating device itself.

In some versions, the testing system 11 can be configured to monitor a health of the sealing system of the reciprocating device. Embodiments of the testing system 11 can be configured to qualitatively monitor the health of the sealing system. In some examples, the testing system 11 can qualitatively monitor the health of the sealing system by rendering images (see, e.g., FIGS. 2 and 3) of an amount of fluid that blows by the reciprocating device.

Embodiments of the computer 41 can use the algorithm stored in memory 404 and executed by processor 402 to relate the pressure of the fluid 13 inside the pipe system 15 to a vibration and dilation of the pipe system 15. For example, the algorithm can use the following equations to solve for the internal pressure of fluid in a pipe system, without directly sampling the fluid. Equation 1 is Lame's hoop stress equation, where σ_{ϑ} is the hoop stress, pᵢ is the internal pressure of the pipe system, rᵢ is the inner radius of the pipe, pₒ is the external pressure on the pipe (which is often negligible, under atmospheric conditions), rₒ is the outer radius of the pipe, and r is the radius at which stress is being evaluated.

$${σ}_{θ} = \frac{{r}_{i}^{2} {P}_{i} - {r}_{o}^{2} {P}_{o}}{( {r}_{o}^{2} - {r}_{i}^{2} )} + \frac{( {P}_{i} - {P}_{o} ) {r}_{i}^{2} {r}_{0}^{2}}{( {r}_{0}^{2} - {r}_{i}^{2} ) {r}^{2}} . \qquad Equation 1$$

Equation 2 is Hooke's Law, which relates stress (σ) and strain (ε), or Cauchy strain, through the material constant E, Young's Modulus, of the pipe material.

σ=Eε Equation 2.

Equation 3 is Cauchy strain, where δᵣₒ is the dilation or change in rₒ (outer radius).

$$ɛ = \frac{{δ}_{{r}_{o}}}{{r}_{o}} . \qquad Equation 3$$

Equation 4 is stress in terms of Young's Modulus (E), δᵣₒ and rₒ.

$$σ = \frac{E {δ}_{{r}_{o}}}{{r}_{o}}$$

Equation 5 is standard internal pressure wherein Pₒ is non-zero (e.g., non-atmospheric external pressure). Substituting Equation 4 into Equation 1 and solving for Pᵢ, while evaluating for r=rₒ yields Equation 5.

$${P}_{i} = \frac{{P}_{o} ( {r}_{o}^{2} + {r}_{i}^{2} )}{2 {r}_{i}^{2}} + \frac{E {δ}_{{r}_{o}} ( {r}_{o}^{2} - {r}_{i}^{2} )}{2 {r}_{i}^{2} {r}_{o}} \qquad Equation 5$$

Equation 6 is a simplified version of Equation 5, when the exterior of the pipe is exposed only to atmospheric pressure, or Pₒ=0.

$${P}_{i} = \frac{E {δ}_{{r}_{o}} ( {r}_{o}^{2} - {r}_{i}^{2} )}{2 {r}_{i}^{2} {r}_{o}} \qquad Equation 6$$

Using Equation 5 or Equation 6 allows for rapid calculation of the pressure internal to the pipe system, given known information (e.g., material, ID, OD) about the pipe system that is static for the measurement point, when the term δᵣₒ is measured with the described accelerometer-based system.

These equations offer a quantitative solution for calculating the internal fluid pressure of a pipe system without equipment that is invasive to the pipe system.

Other embodiments can include a mobile testing system 11 (FIG. 4) for measuring the pulsating pressure of the fluid 13 in dynamic pressure service in the pipe system 15. The mobile testing system 11 can comprise only one sensor 21 configured to be only magnetically mounted to an exterior of the pipe system 15. In this version, the only one sensor 21 is not mounted to the exterior of the pipe system 15 in any other way other than through magnetism.

The mobile testing system 11 can include an analyzer 31 configured to sample and filter data from the only one sensor 21. In addition, the mobile testing system 11 can comprise a computer 41 configured to run an algorithm to convert the data from analyzer 31 to data regarding the pulsating pressure of the fluid 13 in the pipe system 15. The only one sensor can comprise an accelerometer, and not a strain gage. Strain gages require considerably more time to install, must be permanently mounted, and are less robust that accelerometers.

In an example, the analyzer 31 can be configured to require no more time than a few seconds (e.g., about 3 seconds) of data collection from the only one sensor 21 to determine the pulsating pressure of the fluid 13. In some versions, the piping system 15 can comprise one or more magnetic pipes, such as those formed from ferrous, nickel or cobalt materials. In other versions, the piping system 15 can comprise one or more non-magnetic pipes, such as plastic pipes like polyvinylchloride (PVC) pipes. For such applications, the mobile testing system 11 can further comprise a magnetic pad 23 that can be configured to be mounted to the non-magnetic pipe. The only one sensor 21 can be configured to be magnetically and releasably mounted directly to the magnetic pad 23, rather than directly to the piping system 15. Examples of the magnetic pad 23 can be configured to be permanently mounted to the non-magnetic pipe. For example, materials such as epoxy, super glue and the like can be used to mount pad 23 to the pipe.

In addition, the magnetic pad 23 can comprise a plurality of magnetic pads 23. Each pad 23 can be mounted to a different, non-magnetic portion of the pipe system 15. In some versions, the only one sensor 21 can be configured to be magnetically mounted directly to and interchangeably with the various magnetic pads 23. In other versions, the sensor 21 can comprise a plurality of sensors, each of which is mounted to a different portion of the pipe system 15.

In still another embodiment, a testing system 11 can be employed to evaluate an efficiency of a reciprocating system. In some examples, the reciprocating system can include a cylinder 53 (FIG. 1) with a piston 55, an intake port 57 for directing fluid to the piston 55, a discharge port 59 for directing fluid away from the piston 55, and a leak-off pipe 61 coupled to the cylinder 53 for any fluid that blows by the piston 55. Versions of the testing system 11 can include a plurality of sensors 21. At least one of the sensors 21 can be mounted to an exterior of each of the intake port 57, the discharge port 59 and the leak-off pipe 61, without direct contact with and sampling of the fluid inside the reciprocating system.

Such a testing system 11 can further include an analyzer 31 and a computer 41 coupled to the intake port sensor 21 for inferring an intake pressure of the fluid in the intake port 57 based on data from the intake port sensor 21. The term “coupling” can include physical coupling (e.g., Turk five pin to two pin Mil Spec MS 3106M-18-11P-1942-x (777028845), 3000 Campus Drive, Plymouth, Minn. 55441), non-physical coupling (e.g., wireless) or other forms of communication known to those of ordinary skill in the art. A discharge port sensor 21 can be used to infer a discharge pressure of the fluid in the discharge port 59 based on data from the discharge port sensor 21. In addition, a leak-off pipe sensor 21 can be used to infer a leak pressure of the fluid in the leak-off pipe 61 based on data from the leak-off pipe sensor 21. In addition, the testing system 11 can be configured to calculate the efficiency of the reciprocating system based on the intake pressure, the discharge pressure and the leak pressure. An example of an efficiency calculation is provided below.

Embodiments of the analyzer 31 and computer 41 can be configured to calculate the efficiency of the reciprocating system further based on a rotational speed of the reciprocating system, a thickness of a pipe of the reciprocating system, and a modulus of a material of the pipe. In some versions, the reciprocating system can comprise a jacketed pipe having an internal pipe and an external pipe mounted to an exterior of the internal pipe and configured to apply a jacket pressure to the exterior of the internal pipe that exceeds atmospheric pressure. The analyzer 31 and computer 41 can be configured to calculate the efficiency of the reciprocating system further based on the jacket pressure. An example of an efficiency calculation is provided below.

Although FIG. 4 illustrates one example of a mobile device or testing system, various changes can be made to FIG. 4. For example, various components in FIG. 4 could be combined, further subdivided, or omitted and additional components could be added according to particular needs. Also, mobile devices can come in a wide variety of configurations, and FIG. 4 does not limit this disclosure to any particular mobile device.

Quantitative measurement of the pulsating pressure waves causing the pipe dilation can be refined via empirical data acquisition and comparison to established pressure measurement technologies. There exists an equation to relate the Pressure inside a cylindrical body (piping in this case) to the dilation of the cylindrical body. The basic form of this equation is given in Equation 4, which has been derived from Equations 1 and 2. Those equations can be used to calculate stress at a point in a thick-walled pressure vessel, ignoring external pressure and combining terms, while utilizing the stress-strain relationship given in Equation 3.

After establishing a baseline vibration level, using Equation 4, and step-wise double integration to convert the recorded acceleration to displacement, via an algorithm, piping vibration (dilation) can be converted into pressure (inside the pipe) without exposing equipment to the pulsating, cyclical pressure waves of the fluid.

While there is existing art that utilizes a variety of piezoelectric, piezoresistive and other various measurement technologies to measure pressure (both static and dynamic), there are no systems that use an externally-mounted (i.e., not directly exposed to the process fluid) accelerometer in a dynamic pressure application to convert the pipe vibration and dilation into a pressure measurement. With the exception of strain gauges, all other pressure measurement technologies must be exposed to the process fluid. Unfortunately, strain gauges are difficult to install and very delicate, with short life spans. Accelerometers, however, routinely have a mean time before failure that is in the millions of hours. Furthermore, the accelerometer is very mobile, and does not require the rigorous installation required for strain gauges.

In another example, the testing system 11 can be configured to quantitatively monitor the health of the sealing system. Versions of the testing system 11 can be used to calculate a percentage of decay of the sealing system. Both the “health” and the “percentage of decay” of the sealing system can be characterized in terms of the efficiency of the sealing system as described herein.

For example, the following description is provided for the case where there is pulsating flow internal to a piping system, and the external surface of the piping is exposed to atmospheric pressure, allowing Equation 6 to be utilized for rapid internal pressure calculations.

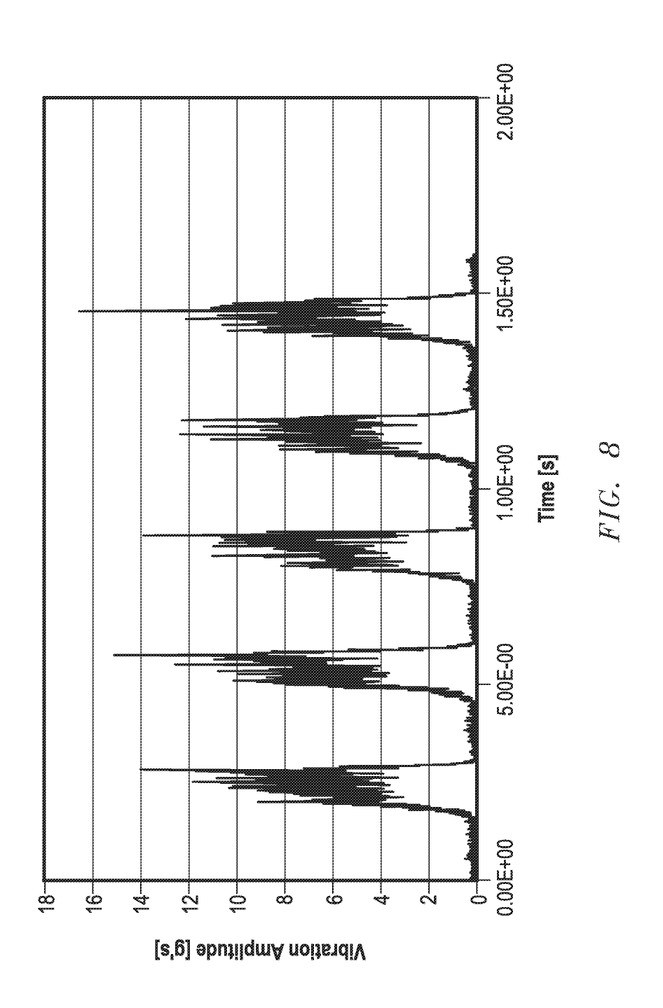

Initially transient acceleration data is collected for at least one pressure cycle. However, more data cycles yield better trend, and are collected in a form such as that shown in FIG. 8.

Acceleration data is stored in a database for conversion to amplitudes with time signatures, as depicted in Table 1.

TABLE 1
Sample data collection in native acceleration
amplitude versus time.

| Time | Amplitude |
|---|---|
| [s] | [g's] |
| 0.00E+00 | 3.09E−01 |
| 3.91E−04 | 4.69E−01 |
| 7.81E−04 | 3.96E−01 |

Integrate numerically using the Trapezoidal Rule (Equation 7) to get velocity data, and then again to get displacement (i.e., pipe dilation). In this case, time is the independent variable, x, while Amplitude is the dependent variable f(x).

Equation 7. Trapezoidal Rule for Numerical Integration.

$${\int }_{a}^{b} f ( x ) dx \approx ( b - a ) \frac{f ( a ) + f ( b )}{2}$$

For the special case where f(x) is a first order polynomial (i.e., a straight line), the integral evaluates the same as the numerical approximation. There is no data lost when converting from acceleration to velocity to displacement, and the error is limited to that accumulated during the physical data collection and by the bin size, or data collection frequency.

In addition, a conversion factor can be used to change the units from G's of acceleration to inches per second squared (Equation 8).

Equation 8. Standard Conversion from G's Units of Acceleration to in/s².

$$0.002590079 {G}^{′} s = \frac{1 in}{{s}^{2}}$$

Equation 9. Example Conversion from Acceleration to Velocity, using Equations 7 and 8.

$$( 0.000391 [ s ] - 0.000000 [ s ] ) ( \frac{0.309 [ {g}^{′} s ] + 0.469 [ {g}^{′} s ]}{2} ) ( \frac{1 [ \frac{in}{{s}^{2}} ]}{0.002590079 [ {g}^{′} s ]} ) = 0.0587 \frac{in}{s}$$

Two acceleration values can be used to calculate each velocity value, as shown in Table 2.

TABLE 2
Example data converted via Equation 3
from acceleration to velocity units.

| Time | Amplitude | Amplitude |
|---|---|---|
| [s] | [Acceleration - g's] | [V - in/s] |
| 0.00E+00 | 3.09E−01 | |
| 3.91E−04 | 4.69E−01 | 5.87E−02 |
| 7.81E−04 | 3.96E−01 | 6.51E−02 |

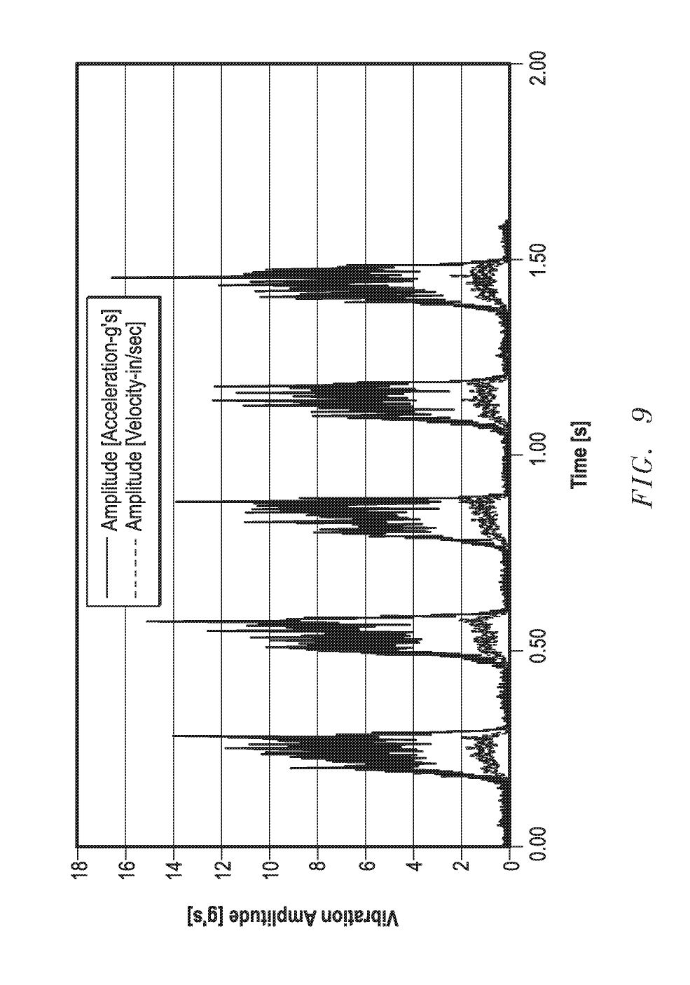

FIG. 9 is a graphical comparison between acceleration and velocity units. The conversion from velocity to displacement uses Equation 7 (again) and does not require a conversion factor, as seen in Equation 10.

Equation 7 can be used in an example conversion from velocity to displacement to yield Equation 10.

$$( 0.000781 [ s ] - 0.000391 [ s ] ) ( \frac{0.0587 [ \frac{in}{s} ] + .0651 [ \frac{in}{s} ]}{2} ) = 0.0000242 [ in ] . \qquad Equation 10$$

Two velocity values are used to calculate a single displacement value, as shown in Table 3.

TABLE 3
Example data converted via Equation 4
from velocity to displacement units.

| Time | Amplitude | Amplitude | Amplitude |
|---|---|---|---|
| [s] | [Acceleration - g's] | [Velocity - in/s] | [Displacement - in] |
| 0.00E+00 | 3.09E−01 | | |
| 3.91E−04 | 4.69E−01 | 5.87E−02 | |
| 7.81E−04 | 3.96E−01 | 6.51E−02 | 2.42E−05 |

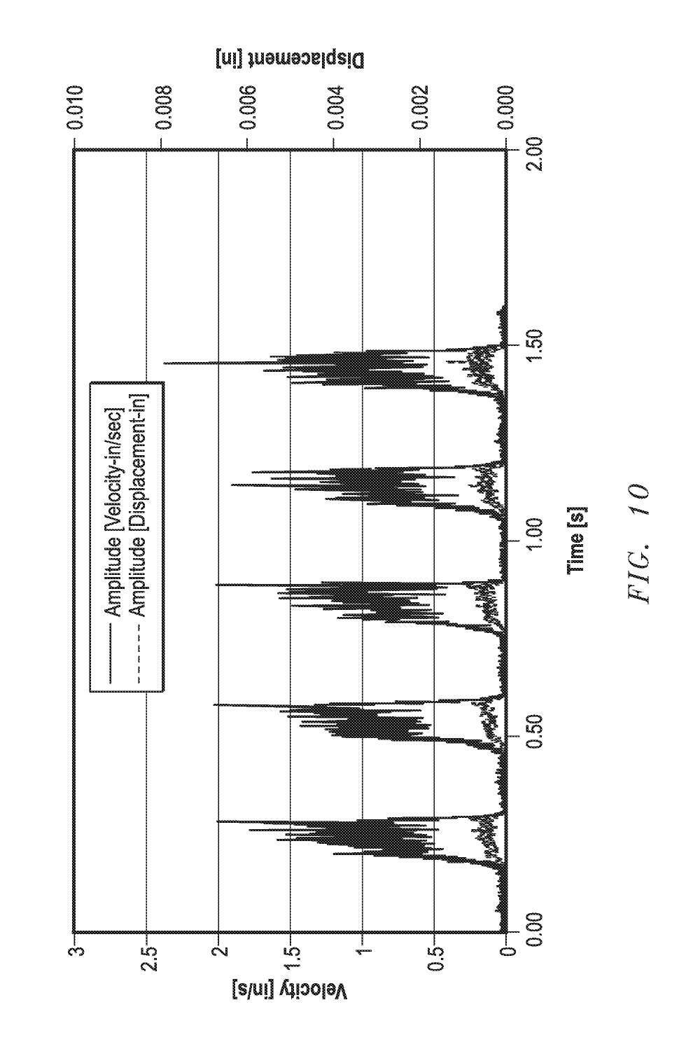

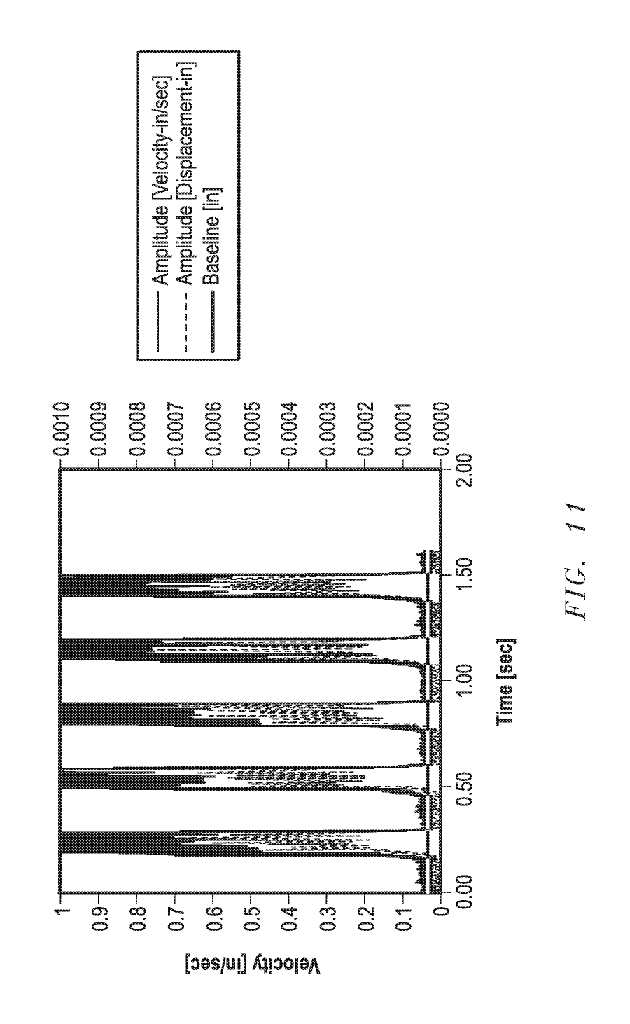

FIG. 10 shows the graphical comparison between velocity and displacement units. Baseline vibration can be established by measuring the vibration of a new cylinder arrangement, or when there is no gas flow, and establishing the maximum amplitude value as the normal maximum. This is illustrated graphically in FIG. 11 as the horizontal line. Algorithmically, this can be determined by selecting the maximum displacement amplitude in a single cycle before the velocity amplitude (or change in displacement over a given time period) increases by an order of magnitude (i.e., from 0.01 in/sec to 0.1 in/sec).

Baseline displacement vibration can be subtracted to yield pressure wave induced vibration (dilation), as show in Table 4. In the cases where the result is less than zero, a zero value is assumed in the example data.

TABLE 4
Example data with adjusted displacement values indicating pressure wave induced dilation.

| Time | Amplitude | Amplitude | Amplitude | Baseline | Adjusted |
|---|---|---|---|---|---|
| [s] | [Acceleration - g's] | [Velocity - in/sec] | [Displacement - in] | [in] | [D] |
| 0.00E+00 | 3.09E−01 | | | | |
| 3.91E−04 | 4.69E−01 | 5.87E−02 | | | |
| 7.81E−04 | 3.96E−01 | 6.51E−02 | 2.42E−05 | 3.67E−05 | 0 |
| 1.17E−03 | 3.13E−01 | 5.35E−02 | 2.32E−05 | 3.67E−05 | 0 |
| — | — | — | — | — | — |
| 1.68E−01 | 7.13E−01 | 1.01E−01 | 3.72E−05 | 3.67E−05 | 5.55968E−07 |
| 1.69E−01 | 7.16E−01 | 1.10E−01 | 4.22E−05 | 3.67E−05 | 5.51334E−06 |
| 1.69E−01 | 1.04E+00 | 1.02E−01 | 3.18E−05 | 3.67E−05 | 0 |
| 1.70E−01 | 9.53E−01 | 1.54E−01 | 5.12E−05 | 3.67E−05 | 1.45324E−05 |
| 1.70E−01 | 1.20E+00 | 1.66E−01 | 6.41E−05 | 3.67E−05 | 2.74432E−05 |
| 1.70E−01 | 1.09E+00 | 1.77E−01 | 6.87E−05 | 3.67E−05 | 3.1999E−05 |
| 1.71E−01 | 1.04E+00 | 1.65E−01 | 6.83E−05 | 3.67E−05 | 3.16284E−05 |
| 1.71E−01 | 1.13E+00 | 1.67E−01 | 6.64E−05 | 3.67E−05 | 2.97134E−05 |
| 1.72E−01 | 1.13E+00 | 1.74E−01 | 6.83E−05 | 3.67E−05 | 3.1582E−05 |
| 1.72E−01 | 1.12E+00 | 1.74E−01 | 6.96E−05 | 3.67E−05 | 3.28793E−05 |
| 1.72E−01 | 8.08E−01 | 1.49E−01 | 6.46E−05 | 3.67E−05 | 2.79219E−05 |
| 1.73E−01 | 7.83E−01 | 1.23E−01 | 5.44E−05 | 3.67E−05 | 1.77137E−05 |

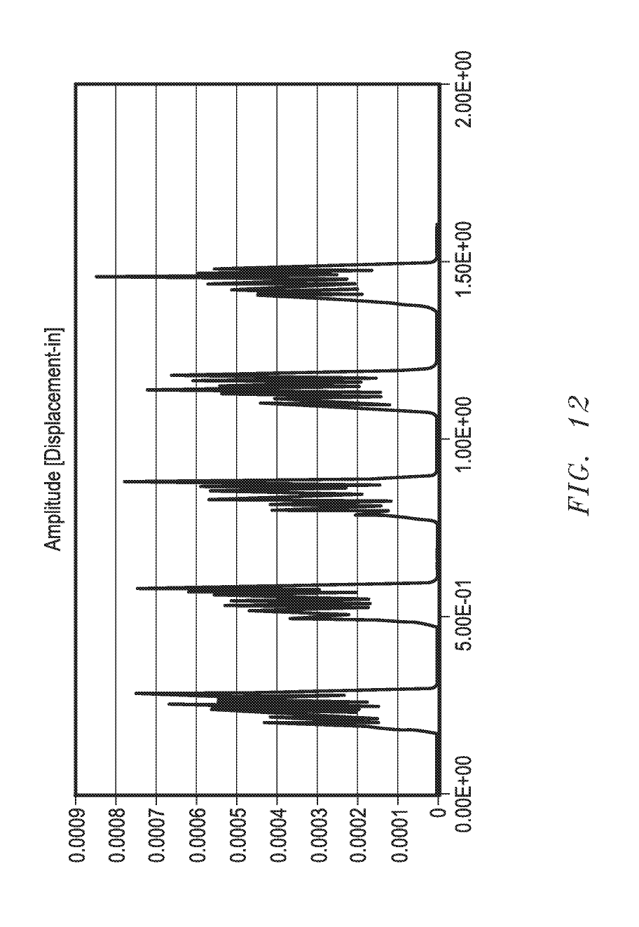

FIG. 12 shows the dilation of the piping due pressure pulsations with the baseline vibration and pressure data removed. Equation 6 can be used to convert pressure wave-induced dilation to pressure in nominal engineering terms, as seen in Table 5, using known parameters of the piping system.

Equation 6 can be used in an example to yield simplified internal pressure in Equation 11.

$${P}_{i} = \frac{\begin{matrix}( 29 , 000 , 000 [ \frac{lb}{{in}^{2}} ] ) ( 5.559688 - 07 [ in ] ) \\ ( {( 0.525 [ in ] )}^{2} - {( 0.371 [ in ] )}^{2} )\end{matrix}}{2 {( 0.371 [ in ] )}^{2} ( 0.925 [ in ] )} = 15.39356 [ psig ] . \qquad Equation 11$$

TABLE 5
Pressure calculations performed on example data.

| | Amplitude | Amplitude | Amplitude | | | |
|---|---|---|---|---|---|---|
| | [Acceleration- | [Velocity- | [Displacement- | Baseline | | Pressure |
| Time [s] | g's] | in/sec] | in] | [in] | Adjusted [D] | [psig] |
| 0.00E+00 | 3.09E−01 | — | — | — | — | — |
| 3.91E−04 | 4.69E−01 | 5.87E−02 | — | — | — | — |
| 7.81E−04 | 3.96E−01 | 6.51E−02 | 2.42E−05 | 3.67E−05 | 0 | 0 |
| 1.17E−03 | 3.13E−01 | 5.35E−02 | 2.32E−05 | 3.67E−05 | 0 | 0 |
| — | — | — | — | — | — | — |
| 1.68E−01 | 7.13E−01 | 1.01E−01 | 3.72E−05 | 3.67E−05 | 5.55968E−07 | 15.39356 |
| 1.69E−01 | 7.16E−01 | 1.10E−01 | 4.22E−05 | 3.67E−05 | 5.51334E−06 | 152.6528 |
| 1.69E−01 | 1.04E+00 | 1.02E−01 | 3.18E−05 | 3.67E−05 | 0 | 0 |
| 1.70E−01 | 9.53E−01 | 1.54E−01 | 5.12E−05 | 3.67E−05 | 1.45324E−05 | 402.3705 |
| 1.70E−01 | 1.20E+00 | 1.66E−01 | 6.41E−05 | 3.67E−05 | 2.74432E−05 | 759.8432 |
| 1.70E−01 | 1.09E+00 | 1.77E−01 | 6.87E−05 | 3.67E−05 | 3.1999E−05 | 885.9849 |
| 1.71E−01 | 1.04E+00 | 1.65E−01 | 6.83E−05 | 3.67E−05 | 3.16284E−05 | 875.7225 |
| 1.71E−01 | 1.13E+00 | 1.67E−01 | 6.64E−05 | 3.67E−05 | 2.97134E−05 | 822.7002 |
| 1.72E−01 | 1.13E+00 | 1.74E−01 | 6.83E−05 | 3.67E−05 | 3.1582E−05 | 874.4397 |
| 1.72E−01 | 1.12E+00 | 1.74E−01 | 6.96E−05 | 3.67E−05 | 3.28793E−05 | 910.358 |
| 1.72E−01 | 8.08E−01 | 1.49E−01 | 6.46E−05 | 3.67E−05 | 2.79219E−05 | 773.0988 |
| 1.73E−01 | 7.83E−01 | 1.23E−01 | 5.44E−05 | 3.67E−05 | 1.77137E−05 | 490.4559 |

To Calculate Efficiency:
1. Sum the pressure values per cycle (at 200 RPM one cycle lasts 0.3 seconds) above the baseline. This can be displayed as a simple integer value indicating the health of the piston/ring/cylinder arrangement.
2. One option for determining the efficiency of this system requires monitoring only a single outlet of the system.
   a. If the primary discharge is being monitored the following equation can be used:

$$η = \frac{current cumulative pressure value \text{/} cycle}{new installation cumulative pressure value \text{/} cycle}$$

Exemplary values of 10,000 and 11,000 are assumed for current and new cumulative values, to demonstrate the detection of a minimal change in system efficiency. The actual values, of course, will depend on the system parameters, such as system health, rotational speed, upstream and downstream pressures, material properties of the piping system and physical characteristics of the piping system (e.g., wall thickness, inner radius, etc.). These exemplary values yield:

$$η = \frac{10 , 000}{11 , 000} = 90.91 \%$$

b. If the leak off line(s) are being monitored the following equation can be used:

$$c . η = 1 - \frac{current culmulative pressure value \text{/} cycle}{failed system cumulative pressure value \text{/} cycle}$$

Exemplary values of 2,500,000 and 7,500,000 are assumed for current and failed cumulative values, to demonstrate the detection of a loss of one-third efficiency. The actual values, of course, will depend on the system parameters, such as system health, rotational speed, upstream and downstream pressures, material properties of the piping system and physical characteristics of the piping system (e.g., wall thickness, inner radius, etc.). These exemplary values yield:

$$η = 1 - \frac{2500000}{7500000} = 66.67 \%$$

This calculation means that the tested cylinder is operating at about 67% efficiency. Based on this efficiency, a determination can be made whether it would be cost effective to repair or replace the tested cylinder.

As the above descriptions reveal, the fluid pressure inside a pipe can be advantageously determined based upon acceleration measurements taken at a location on the external surface of the pipe, without requiring a sensor to be directly exposed to the fluid within the pipe. Such acceleration measurements (i.e., acceleration data) reflect the axial dilation of the pipe caused by the pulsating pressure waves within the pipe. In other words, the pipe actually expands and contracts in response to the pulsating pressure waves within the pipe, and the pulsating change in pipe size can be determined by doubly-integrating the acceleration data to yield displacement data reflecting the pulsating change in pipe radius. Using certain material properties of the pipe, which colloquially can be viewed as representing the “stretchability” of the pipe walls, the pulsating, cyclical fluid pressure inside the pipe can then be determined. Such cyclical fluid pressure can then be correlated to the rotation of a multiple-cylinder compressor or other device to more reliably identify one or more specific cylinders in need of repair or replacement. This affords tremendous cost saving opportunities by reducing unnecessary downtime and needless repairs.

Exemplary computational algorithms for making such determinations utilize certain mathematical equations. One such equation relates the pressure inside a cylindrical body (e.g., piping) to the dilation of the cylindrical body. The basic form of this equation is given in Equation 4, which has been derived from Equations 1 and 2. Those equations can be used to calculate stress at a point in a thick-walled pressure vessel, ignoring external pressure and combining terms, while utilizing the stress-strain relationship given in Equation 3. After establishing a baseline vibration level, using Equation 4, and double integration to convert the recorded acceleration to displacement, piping vibration (dilation) can be converted into fluid pressure within the pipe without exposing equipment to the pulsating, cyclical pressure waves of the fluid. It should be appreciated that use of these equations as described herein, in combination with specific sensor and computational configurations coupled to a piping system, to determine internal cyclical fluid pressure based on external pipe surface acceleration data, in no way removes such equations from the body of scientific knowledge for research, and in no way preempts the use of such equations for other purposes.

It should again be noted that there are no known systems that use an externally-mounted accelerometer that is not directly exposed to the process fluid, in a dynamic pressure application, to convert the pipe vibration and dilation into a pressure measurement. Available accelerometers are extremely reliable, mechanically robust, and are easy to install on an external surface of a pipe, using any of several different mounting or attachment techniques described above. In contrast, strain gauges are difficult to install and very delicate, with short life spans. Moreover, all other known pressure measurement technologies must be exposed to the process fluid.

Other versions can include one or more of the following embodiments:

Embodiment 1. A testing system for pulsating pressure measurement of a pressure of a fluid in a pipe system, the testing system comprising:

only one accelerometer mounted to an exterior of the pipe system;

an analyzer coupled to the only one accelerometer to sample and filter data from the only one accelerometer; and

a computer coupled to the analyzer to run an algorithm to convert the sampled and filtered data to data regarding the pressure of the fluid in the pipe system.

Embodiment 2. The testing system of any of these embodiments, wherein the only one accelerometer is the only sensor of the testing system, such that the testing system comprises no other sensors.

Embodiment 3. The testing system of any of these embodiments, wherein the testing system comprises no sensors, including the only one accelerometer, that are directly exposed to the fluid for directly monitoring the fluid in the pipe system.

Embodiment 4. The testing system of any of these embodiments, wherein a sampling rate of the analyzer is in a range of about 100,000 to about 125,000 samples per second.

Embodiment 5. The testing system of any of these embodiments, wherein a filtering capability of the analyzer comprises a high pass filter applied to a waveform of the data from the only one accelerometer, and the high pass filter limits the data from the only one accelerometer to the analyzer to vibrations at a frequency of at least about 1000 Hz.

Embodiment 6. The testing system of any of these embodiments, wherein the only one accelerometer is directly mounted to a pipe of the pipe system at an outer diameter of the pipe.

Embodiment 7. The testing system of any of these embodiments, wherein the only one accelerometer detects vibration in and dilation of an outer diameter of a pipe of the pipe system, with which the computer can infer the pressure of the fluid in the pipe system.

Embodiment 8. The testing system of any of these embodiments, further comprising a pad directly mounted to an exterior of a pipe of the pipe system, and the only one accelerometer is directly mounted to the pad, such that the only one accelerometer is not directly mounted to the pipe system.

Embodiment 9. The testing system of any of these embodiments, wherein the pressure of the fluid in the pipe system is in a range of about 200 psi to about 25,000 psi.

Embodiment 10. The testing system of any of these embodiments, wherein the pipe system is in fluid communication with a reciprocating device that creates the pressure in the pipe system.

Embodiment 11. The testing system of any of these embodiments, wherein the reciprocating device comprises a compressor or a pump, and the only one accelerometer is located downstream from the compressor or the pump.

Embodiment 12. The testing system of any of these embodiments, wherein the compressor comprises a cylinder with a piston, an intake port for directing fluid to the piston, a discharge port for directing fluid away from the piston, and a leak-off pipe coupled to the cylinder for any of the fluid that blows by the piston.

Embodiment 13. The testing system of any of these embodiments, wherein the compressor comprises a sealing system between the cylinder and the piston, and the testing system monitors a health of the sealing system.

Embodiment 14. The testing system of any of these embodiments, wherein the sealing system comprises a packing or piston rings.

Embodiment 15. The testing system of any of these embodiments, wherein the testing system qualitatively monitors the health of the sealing system by rendering images of an amount of fluid that blows by the piston.

Embodiment 16. The testing system of any of these embodiments, wherein the testing system quantitatively monitors the health of the sealing system by calculating a percentage of decay of the sealing system.

Embodiment 17. The testing system of any of these embodiments, wherein the only one accelerometer is mounted to the leak-off pipe.

Embodiment 18. The testing system of any of these embodiments, wherein the only one accelerometer is only magnetically mounted to one of the intake port, the discharge port and the leak-off pipe.

Embodiment 19. The testing system of any of these embodiments, wherein the algorithm relates the pressure of the fluid inside the pipe system to a vibration and dilation of the pipe system.

Embodiment 20. A mobile testing system for measuring a pulsating pressure of a fluid in a pipe system, the mobile testing system comprising:

only one sensor configured to be only magnetically mounted to an exterior of the pipe system, such that the only one sensor is not mounted to the exterior of the pipe system in any other way other than through magnetism;

an analyzer configured to sample and filter data from the only one sensor; and

a computer configured to run an algorithm to convert the sampled and filtered data to data regarding the pulsating pressure of the fluid in the pipe system.

Embodiment 21. The mobile testing system of any of these embodiments, wherein the analyzer is configured to require no more than about 3 seconds of data collection from the only one sensor for the computer to determine the pulsating pressure.

Embodiment 22. The mobile testing system of any of these embodiments, wherein the piping system comprises a non-magnetic pipe, the mobile testing system further comprises a magnetic pad configured to be mounted to the non-magnetic pipe, and the only one sensor is configured to be magnetically and releasably mounted directly to the magnetic pad.

Embodiment 23. The mobile testing system of any of these embodiments, wherein the magnetic pad is configured to be permanently mounted to the non-magnetic pipe.

Embodiment 24. The mobile testing system of any of these embodiments, wherein the magnetic pad comprises a plurality of magnetic pads, each of which is mounted to a different, non-magnetic portion of the pipe system, and the only one sensor is configured to be magnetically mounted directly to and interchangeably with the plurality of magnetic pads.

Embodiment 25. A testing system for pulsating pressure measurement of a pressure of a fluid in a pipe system, the testing system comprising:

at least one accelerometer mounted to the piping system, wherein the at least one accelerometer is mounted to an exterior of a pipe of the piping system and measures vibration in and dilation of an outer diameter of the pipe;

an analyzer coupled to the at least one accelerometer, wherein the analyzer samples and filters data from the at least one accelerometer; and

a computer coupled to the analyzer, wherein the computer runs an algorithm to convert the sampled and filtered data to data to infer the pressure of the fluid in the pipe system.

Embodiment 26. The testing system of any of these embodiments, wherein the at least one accelerometer comprises a plurality of accelerometers, each of which is mounted to a different portion of the pipe system.

Embodiment 27. A testing system for evaluating an efficiency of a reciprocating system having a cylinder with a piston, an intake port for directing a fluid to the piston, a discharge port for directing the fluid away from the piston, and a leak-off pipe coupled to the cylinder for any of the fluid that blows by the piston, the testing system comprising:

a plurality of sensors, wherein at least one of the sensors is mounted to an exterior of each of the intake port, the discharge port and the leak-off pipe, without direct contact with and sampling of the fluid inside the reciprocating system;

a computation system coupled to:

the intake port sensor for inferring an intake pressure of the fluid in the intake port based on data from the intake port sensor;

the discharge port sensor for inferring a discharge pressure of the fluid in the discharge port based on data from the discharge port sensor; and

the leak-off pipe sensor for inferring a leak pressure of the fluid in the leak-off pipe based on data from the leak-off pipe sensor; and

the computation system calculates the efficiency of the reciprocating system based on the intake pressure, the discharge pressure and the leak pressure.

Embodiment 28. The testing system of any of these embodiments, wherein the computation system calculates the efficiency of the reciprocating system further based on a rotational speed of the reciprocating system, a thickness of a pipe of the reciprocating system, and a modulus of a material of the pipe.

Embodiment 29. The testing system of any of these embodiments, wherein the reciprocating system comprises a jacketed pipe having an internal pipe and an external pipe mounted to an exterior of the internal pipe, wherein the external pipe is configured to apply a jacket pressure to the exterior of the internal pipe that exceeds atmospheric pressure; and

the computation system calculates the efficiency of the reciprocating system further based on the jacket pressure.

Embodiment 30. An analyzer, comprising:

a transceiver configured to sample data from at least one sensor;

a filter configured to filter the sample data received by the transceiver; and

a processor configured to control a sampling rate of the analyzer.

Embodiment 31. The analyzer of any of these embodiments, wherein the filter is a high pass filter.

Embodiment 32. The analyzer of any of these embodiments, wherein the high pass filter is configured to filter out signals greater than 1 kHz.

Embodiment 33. The analyzer of any of these embodiments, wherein the sampling rate is in a range of about 100,000 to about 125,000 samples per second.

Embodiment 34. The analyzer of any of these embodiments, wherein the transceiver is configured to sample the sensor less than 3 seconds.

Embodiment 35. The analyzer of any of these embodiments, wherein the at least one sensor is mounted to an exterior of a pipe system.

Embodiment 36. The analyzer of any of these embodiments, wherein the at least one sensor includes a plurality of sensors.

Embodiment 37. The analyzer of any of these embodiments, wherein the at least one sensor is an accelerometer.

Embodiment 38. A computer configured to determine a pressure of a fluid in a pipe system, the computer comprising:

a memory configured to store an algorithm, the algorithm being used to convert sampled data to a pressure value;

a transceiver configured to receive the sampled data from an analyzer;

a processor configured to execute the algorithm to convert the sampled data to the pressure value.

Embodiment 39. The computer of any of these embodiments, wherein the sampled data received by the transceiver is high pass filtered.

Embodiment 40. The computer of any of these embodiments, wherein the pipe system includes a sealing system and the processor is configured to monitor a health of the sealing system by calculating a percentage of decay of the sealing system.

Embodiment 41. The computer of any of these embodiments, wherein the algorithm relates the pressure of the fluid inside the pipe system to a vibration and dilation of the pipe system.

Embodiment 42. A testing system for evaluating an efficiency of a reciprocating system having a cylinder with a piston, an intake port for directing a fluid to the piston, a discharge port for directing the fluid away from the piston, and a leak-off pipe coupled to the cylinder for any of the fluid that blows by the piston, the testing system comprising:

an accelerometer mounted to an exterior of at least one of the intake port, the discharge port or the leak-off pipe, without direct contact with and sampling of the fluid inside the reciprocating system, and a pipe system in fluid communication with the cylinder and piston which form pressure in the reciprocating system; and

a computation system coupled to at least one of:

the accelerometer as an intake port sensor for inferring an intake pressure of the fluid in the intake port based on data from the intake port sensor;

the accelerometer as a discharge port sensor for inferring a discharge pressure of the fluid in the discharge port based on data from the discharge port sensor; or

the accelerometer as a leak-off pipe sensor for inferring a leak pressure of the fluid in the leak-off pipe based on data from the leak-off pipe sensor; and

the computation system is operable to determine the efficiency of the reciprocating system based on at least one of the intake pressure, the discharge pressure or the leak pressure.

Embodiment 43. The testing system of any of these embodiments, wherein the accelerometer consists of only one accelerometer and is the only sensor of the testing system, such that the testing system comprises no other sensors that are used to determine fluid pressure.

Embodiment 44. The testing system of any of these embodiments, wherein:

a sampling rate of the computation system is in a range of about 100,000 to about 125,000 samples per second; and

the pressure of the fluid in the reciprocating system is in a range of about 200 psi to about 25,000 psi.

Embodiment 45. The testing system of any of these embodiments, wherein a filtering capability of the computation system comprises a high pass filter applied to a waveform of data from the sensor, and the high pass filter limits data from the sensor at a frequency of at least about 1000 Hz.

Embodiment 46. The testing system of any of these embodiments, wherein data from the sensor is reflective of vibration in and dilation of an outer diameter of a pipe of the reciprocating system, from which the computer can infer a pressure of the fluid in the reciprocating system.

Embodiment 47. The testing system of any of these embodiments, wherein the computer is operable to determine the cyclic fluid pressure by:

determining, based upon the accelerometer data, the amount of dilation at the exterior of the pipe system where the accelerometer is mounted; then

determining, based on the determined amount of dilation, and further based upon physical properties of the pipe, the cyclical fluid pressure.

Embodiment 48. The testing system of any of these embodiments, wherein the computer is operable to determine the amount of dilation at the exterior of the pipe system by:

integrating the sampled and filtered accelerometer data to determine corresponding velocity data at the exterior of the pipe system where the accelerometer is mounted; then

integrating the velocity data to determine corresponding displacement data representing dilation at the exterior of the pipe system where the accelerometer is mounted.

Embodiment 49. The testing system of any of these embodiments, wherein the computer is operable determine the cyclical fluid pressure using the following equation:

$${P}_{i} = \frac{E {δ}_{{r}_{o}} ( {r}_{o}^{2} - {r}_{i}^{2} )}{2 {r}_{i}^{2} {r}_{o}}$$

where rᵢ is the inner radius of the pipe, rₒ is the outer radius of the pipe, δᵣₒ is the determined dilation or change in rₒ, E is the Young's Modulus of the pipe material, and Pᵢ is the internal pressure of the pipe system.

Embodiment 50. The testing system of any of these embodiments, further comprising a pad directly mounted to an exterior of the reciprocating system, and the sensor is directly mounted to the pad, such that the sensor is not directly mounted to the reciprocating system.

Embodiment 51. The testing system of any of these embodiments, wherein the reciprocating system comprises a compressor or a pump, and the sensor is located downstream from the compressor or the pump.

Embodiment 52. The testing system of any of these embodiments, wherein the compressor or pump comprises a plurality of cylinders, each respective cylinder has a piston, and each respective cylinder has an operational cycle corresponding to a respective rotational position of the compressor or pump.

Embodiment 53. The testing system of any of these embodiments, wherein:

the pressure of the fluid in the pipe system is a cyclical fluid pressure; and

the computer is further operable to correlate the cyclical fluid pressure with the rotational position of the compressor or pump, to identify one or more cylinders having degraded performance relative to remaining cylinders.

Embodiment 54. The testing system of any of these embodiments, wherein the compressor comprises a sealing system between the cylinder and the piston, and the testing system monitors a health of the sealing system.

Embodiment 55. The testing system of any of these embodiments, wherein the sealing system comprises a packing or piston rings, the testing system is operable to qualitatively monitor the health of the sealing system by rendering images of an amount of fluid that blows by the piston, and the testing system is operable to qualitatively monitor the health of the sealing system by calculating a percentage of decay of the sealing system.

Embodiment 56. The testing system of any of these embodiments, wherein the computation system is configured to require no more than about 3 seconds of data collection from the accelerometer to determine the pressure in the reciprocating system.

Embodiment 57. The mobile testing system of any of these embodiments, wherein the pipe system comprises non-magnetic pipe, the testing system further comprises a magnetic pad configured to be mounted to the non-magnetic pipe, and the accelerometer is configured to be magnetically and releasably mounted directly to the magnetic pad.

Embodiment 58. The testing system of any of these embodiments, wherein the magnetic pad is configured to be permanently mounted to the non-magnetic pipe.

Embodiment 59. The testing system of any of these embodiments, wherein the magnetic pad comprises a plurality of magnetic pads, each of which is mounted to a different, non-magnetic portion of the pipe system, and the accelerometer is configured to be magnetically mounted directly to and interchangeable with the plurality of magnetic pads.

Embodiment 60. The testing system of any of these embodiments, wherein the accelerometer comprises a plurality of accelerometers, each of which is mounted to a different portion of the pipe system.

Embodiment 61. The testing system of any of these embodiments, wherein the computation system is operable to determine the efficiency of the reciprocating system further based on a rotational speed of the reciprocating system, a thickness of a pipe of the reciprocating system, and a modulus of a material of the pipe.

Embodiment 62. The testing system of any of these embodiments, wherein the reciprocating system comprises a jacketed pipe having an internal pipe and an external pipe mounted to an exterior of the internal pipe, wherein the external pipe is configured to apply a jacket pressure to the exterior of the internal pipe that exceeds atmospheric pressure; and

the computation system is operable to determine the efficiency of the reciprocating system further based on the jacket pressure.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity is not necessarily required, and that one or more further activities can be performed in addition to those described. Still further, the order in which activities are listed is not necessarily the order in which they must be performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. For example, although certain embodiments include an analyzer and a computer, each with described functionality, the functions performed by each of these two devices may be partitioned differently, with the computer performing more or less than that described above, and the analyzer correspondingly performing less or more than described above. Moreover, the analyzer and the computer need not be implemented as separate devices. Rather, the functions performed by both the analyzer and computer can be performed by a single structural block, such as a computational system, that may be implemented as one or more than one identifiably-distinct devices. As another example, integration of acceleration data to determine velocity, and further integration to determine displacement (e.g., pipe dilation), need not be performed using a trapezoidal method (“step-wise integration”), but can alternatively be performed using other integration techniques.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It can be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list may be needed. For example, “at least one of: A, B, and C” includes any of the following combinations: A, B, C, A and B, A and C, B and C, and A and B and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

What is claimed is:

1. A testing system for evaluating an efficiency of a reciprocating system having a cylinder with a piston, an intake port for directing a fluid to the piston, a discharge port for directing the fluid away from the piston, and a leak-off pipe coupled to the cylinder for any of the fluid that blows by the piston, the testing system comprising:
an accelerometer mounted to an exterior of at least one of the intake port, the discharge port or the leak-off pipe, without direct contact with and sampling of the fluid inside the reciprocating system, and a pipe system in fluid communication with the cylinder and piston which form pressure in the reciprocating system; and
a computation system coupled to at least one of:
the accelerometer as an intake port sensor for inferring an intake pressure of the fluid in the intake port based on data from the intake port sensor;
the accelerometer as a discharge port sensor for inferring a discharge pressure of the fluid in the discharge port based on data from the discharge port sensor; or
the accelerometer as a leak-off pipe sensor for inferring a leak pressure of the fluid in the leak-off pipe based on data from the leak-off pipe sensor; and
the computation system is operable to determine the efficiency of the reciprocating system based on at least one of the intake pressure, the discharge pressure or the leak pressure.

2. The testing system of claim 1, wherein the accelerometer consists of only one accelerometer and is the only sensor of the testing system, such that the testing system comprises no other sensors that are used to determine fluid pressure.

3. The testing system of claim 1, wherein:
a sampling rate of the computation system is in a range of about 100,000 to about 125,000 samples per second; and
the pressure of the fluid in the reciprocating system is in a range of about 200 psi to about 25,000 psi.

4. The testing system of claim 1, wherein a filtering capability of the computation system comprises a high pass filter applied to a waveform of data from the sensor, and the high pass filter limits data from the sensor at a frequency of at least about 1000 Hz.

5. The testing system of claim 1, wherein data from the sensor is reflective of vibration in and dilation of an outer diameter of a pipe of the reciprocating system, from which the computer can infer a pressure of the fluid in the reciprocating system.

6. The testing system of claim 5, wherein the computer is operable to determine the cyclic fluid pressure by:
determining, based upon the accelerometer data, the amount of dilation at the exterior of the pipe system where the accelerometer is mounted; then
determining, based on the determined amount of dilation, and further based upon physical properties of the pipe, the cyclical fluid pressure.

7. The testing system of claim 6, wherein the computer is operable to determine the amount of dilation at the exterior of the pipe system by:
integrating the sampled and filtered accelerometer data to determine corresponding velocity data at the exterior of the pipe system where the accelerometer is mounted; then
integrating the velocity data to determine corresponding displacement data representing dilation at the exterior of the pipe system where the accelerometer is mounted.

8. The testing system of claim 6, wherein the computer is operable determine the cyclical fluid pressure using the following equation:
$${P}_{i} = \frac{E {δ}_{{r}_{o}} ( {r}_{o}^{2} - {r}_{i}^{2} )}{2 {r}_{i}^{2} {r}_{o}}$$
where rᵢ is the inner radius of the pipe, rₒ is the outer radius of the pipe, δᵣₒ is the determined dilation or change in rₒ, E is the Young's Modulus of the pipe material, and Pᵢ is the internal pressure of the pipe system.

9. The testing system of claim 1, further comprising a pad directly mounted to an exterior of the reciprocating system, and the sensor is directly mounted to the pad, such that the sensor is not directly mounted to the reciprocating system.

10. The testing system of claim 1, wherein the reciprocating system comprises a compressor or a pump, and the sensor is located downstream from the compressor or the pump.

11. The testing system of claim 10, wherein the compressor or pump comprises a plurality of cylinders, each respective cylinder has a piston, and each respective cylinder has an operational cycle corresponding to a respective rotational position of the compressor or pump.

12. The testing system of claim 11, wherein:
the pressure of the fluid in the pipe system is a cyclical fluid pressure; and
the computer is further operable to correlate the cyclical fluid pressure with the rotational position of the compressor or pump, to identify one or more cylinders having degraded performance relative to remaining cylinders.

13. The testing system of claim 10, wherein the compressor comprises a sealing system between the cylinder and the piston, and the testing system monitors a health of the sealing system.

14. The testing system of claim 13, wherein the sealing system comprises a packing or piston rings, the testing system is operable to qualitatively monitor the health of the sealing system by rendering images of an amount of fluid that blows by the piston, and the testing system is operable to qualitatively monitor the health of the sealing system by calculating a percentage of decay of the sealing system.

15. The testing system of claim 1, wherein the computation system is configured to require no more than about 3 seconds of data collection from the accelerometer to determine the pressure in the reciprocating system.

16. The mobile testing system of claim 1, wherein the pipe system comprises non-magnetic pipe, the testing system further comprises a magnetic pad configured to be permanently mounted to the non-magnetic pipe, and the accelerometer is configured to be magnetically and releasably mounted directly to the magnetic pad.

17. The testing system of claim 16, wherein the magnetic pad comprises a plurality of magnetic pads, each of which is mounted to a different, non-magnetic portion of the pipe system, and the accelerometer is configured to be magnetically mounted directly to and interchangeable with the plurality of magnetic pads.

18. The testing system of claim 1, wherein the accelerometer comprises a plurality of accelerometers, each of which is mounted to a different portion of the pipe system.

19. The testing system of claim 1, wherein the computation system is operable to determine the efficiency of the reciprocating system further based on a rotational speed of the reciprocating system, a thickness of a pipe of the reciprocating system, and a modulus of a material of the pipe.

20. The testing system of claim 1, wherein the reciprocating system comprises a jacketed pipe having an internal pipe and an external pipe mounted to an exterior of the internal pipe, wherein the external pipe is configured to apply a jacket pressure to the exterior of the internal pipe that exceeds atmospheric pressure; and
the computation system is operable to determine the efficiency of the reciprocating system further based on the jacket pressure.
